(19) United States
(12) Patent Application Publication
(10) Pub. No.: US 2007/0253639 A1
(43) Pub. Date: Nov. 1, 2007

(54) Imagery analysis tool

(75) Inventor: Donald R. Statter JR., Lusby, MD (US)

Correspondence Address: NAVAL AIR WARFARE CENTER AIRCRAFT;DIVISION OFFICE OF COUNSEL BLDG 435, SUITE A, 47076 LILJENCRANTZ ROAD UNIT 7, PATUXENT RIVER, MD, 20670, US

(73) Assignee: The United States of America as represented by the Secretary of the Navy

(21) Appl. No.: 11/417,283

(22) Filed: May 1, 2006

(51) Int. Cl. G06K 9/36

(52) U.S. Cl. 382/276

(57) ABSTRACT

An imagery analysis tool that obtains imagery from imagery collections systems, orthorectifies the imagery such that resultant imagery reads like a map, and geocodes the resultant imagery such that all feature objects can be plotted as vector icons.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to an imagery analysis tool. More specifically, but without limitation, the present invention relates to an imagery analysis tool to support strike operations planning.

In many parts of the world where the United States Navy is tasked to operate, existing National Geospatial Agency (NGA) products are not well suited to Strike Operations support because they are not of appropriate scale, latency, content, or resolution detail to support Strike related planning activities. Similarly, National Technical Means (NTM) systems are difficult for local Theatre Commanders to effectively task when and where they are critically needed. National systems are generally well suited to provide intelligence information about fixed targets at known locations. Tactical airborne Intelligence, Surveillance, and Reconnaissance (ISR) systems are better suited to reacting to adhoc threats that move beyond the established norms of known target location and activity periodicity. The cornerstone of Network Centric Warfare (NCW) is the use of tactical airborne ISR sensor systems, under theatre commander control, that can collect in all-weather, all-light conditions. In effect, NCW is transitioning intelligence capability from NTM to theatre ISR sensor assets, in order to react inside the enemies' observe-orient-decide-attack (OODA) cycle, because the existing NTM systems cannot. Additionally, national system architectures require extensive system administration and maintenance support that might be difficult or cost prohibitive for forward-deployed units within ships, submarines, ground vehicles, or aircraft. Thus there is a need for a system that provides forward deployed war fighters a near real-time capability to detect, identify, analyze and track mobile targets that move beyond the established norms of known target location and collection periodicity.

Thus, there is a need in the art to provide an information system without the limitations inherent in present methods.

### SUMMARY

It is a feature of the invention to provide an imagery analysis tool. The imagery analysis tool is a computer software system that has a set of instructions for controlling a general purpose digital computer in performing a desired function, the functions including: obtaining imagery from imagery collections systems; warping, scaling and rotating the imagery into a groundplane such that resultant imagery reads like a map; and geocoding the resultant imagery such that all feature objects can be plotted as vector icons.

It is a feature of the invention to perform image orthorectification by use of Digital Terrain Elevation Data such that tactical airborne imagery collections can be effectively warped, scaled and rotated into a projection ground plane in order that resultant imagery reads like a map.

It is a feature of the invention to provide an imagery analysis that may combine imagery from many sources, create and display a near real-time 3-Dimensional image of an area.

It is another feature of the invention to provide an imagery analysis tool that can show geographic coordinates for the plotting of precise 3-axis target coordinates from digital maps and imagery.

It is a feature of the invention to provide a software application that can perform specific data fusion tasks for imagery exploitation from any part of the sensor spectrum.

It is a feature of the invention to provide a an imagery analysis tool that has the ability to produce large area digital synthetic aperture radar imagery mosaics merged into the ground plane.

### BRIEF DESCRIPTION OF THE DRAWINGS

These and other features, aspects and advantages of the present invention will become better understood with reference to the following description and appended claims, and accompanying drawings wherein:

FIG. 1 shows a depiction of orthorectification;

FIG. 2 shows a depiction of geocoding;

FIG. 3 shows a depiction of the elevation feature of the imagery analysis tool;

FIG. 4 shows a depiction of the merge capability of the imagery analysis tool; and

FIG. 5 shows a depiction of creating the large area mosaic.

### DETAILED DESCRIPTION

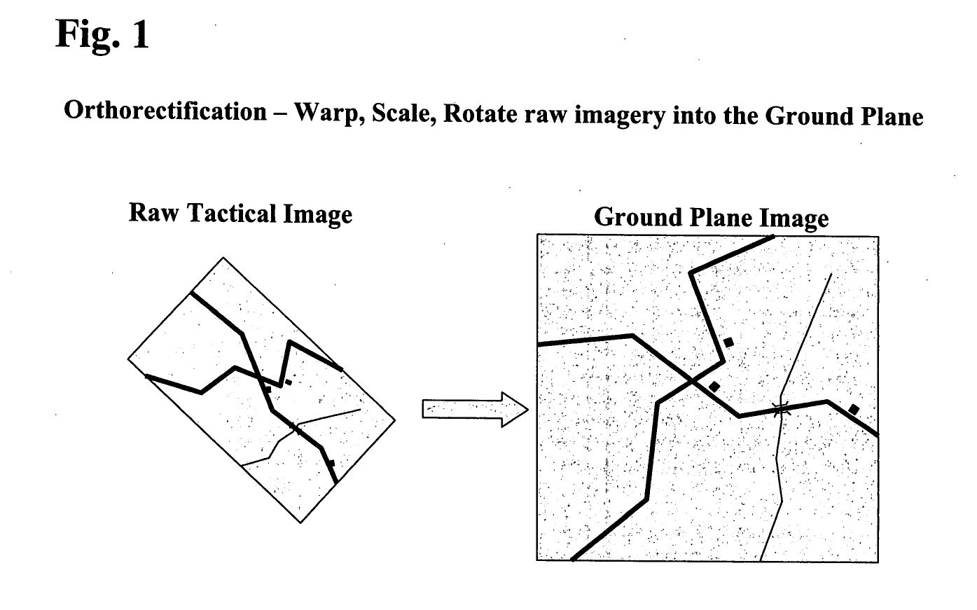

The preferred embodiment of the present invention is illustrated by way of example below and in FIGS. 1-5. In the preferred embodiment, the imagery analysis tool may reside within a computer software system. The computer software system for imagery analysis is a system having a set of instructions for controlling a general purpose digital computer in performing a desired function, the functions including, obtaining imagery from imagery collections systems, orthorectifying the imagery such that resultant imagery reads like a map, and geocoding the resultant imagery such that all feature objects can be plotted as vector icons.

In the discussion of the present invention, the system will be discussed in a military environment, specifically a tactical strike support environment, however, the system can also be utilized for other type of uses.

The imagery that is obtained may include, but without limitation, reconnaissance film, video tape, charts, paper graphics, maps, topographical maps, digital terrain data, radar imagery, infrared imagery, and electro-optic imagery. The imagery collection systems may be, but without limitations, map databases, reconnaissance aircraft (unmanned or manned), military databases, national security databases or any type of system having the ability to collect and/or store images and geospatial information.

After the imagery is obtained, as seen in FIG. 1, it is orthorectified such that the resultant imagery reads like a map. Orthorectifing may be defined, but without limitation, as warping, scaling and rotating an image into a groundplane. Warping may be defined, but without limitation, as plotting the imagery into two-dimensional rectilinear geometry such that X and Y dimensions are equal, and all terrain distortion effects are corrected by use of existing three dimensional digital terrain elevation data. Scaling may be defined, but without limitation, as making the imagery in accordance to the relative sizes of each object displayed within the imagery or making the imagery a specific user defined dimension relationship. In the preferred embodiment, the imagery appears as three dimensional digital terrain elevation data. Image rotation may be defined, but without limitation, as the process of orienting the image to a specific azimuth angle. An image is typically oriented to a specific azimuth angle when True North (the geographical north pole) will plot along the top of the image scene as any map would be generally displayed.

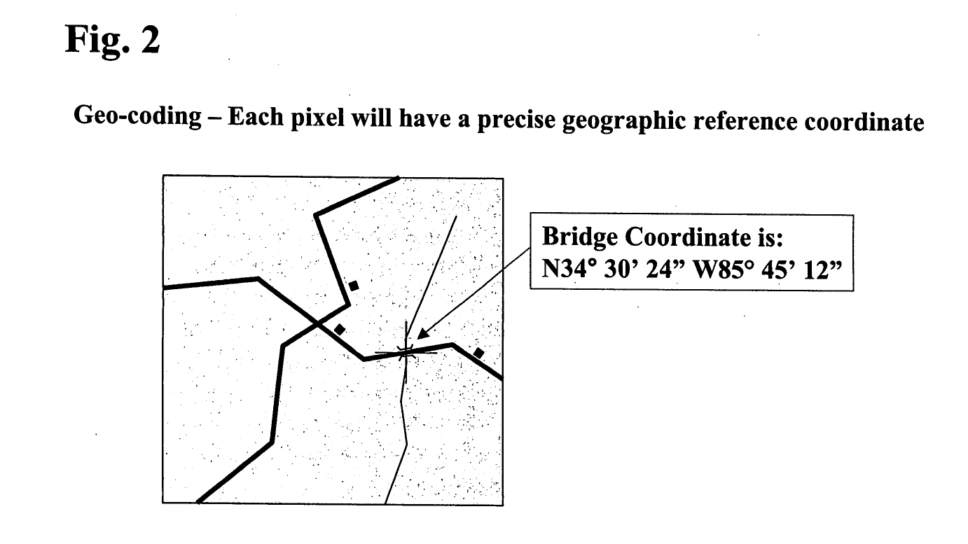

Once the imagery is orthorectified, the imagery is geocoded (as shown in FIG. 2). Geocoding may be defined, but without limitation, as defining precise geographic coordinates for each pixel within the image scene. These geographic coordinates may be standard global coordinates that allow the user to find a particular point on any type of map or imagery, and be able to pinpoint a specific location throughout the world. Geocoding will facilitate the creation of vector icons that result from user analysis processes. Vector icons are a transportable feature object that can be transmitted from one user to another via standard Internal Protocol (IP) systems, at low bandwidth, without sending an entire map or image. In effect, image geocoding and the resultant vector icon transfer capability will enhance effective Strike targeting operations capability in a Network Centric Warfare environment.

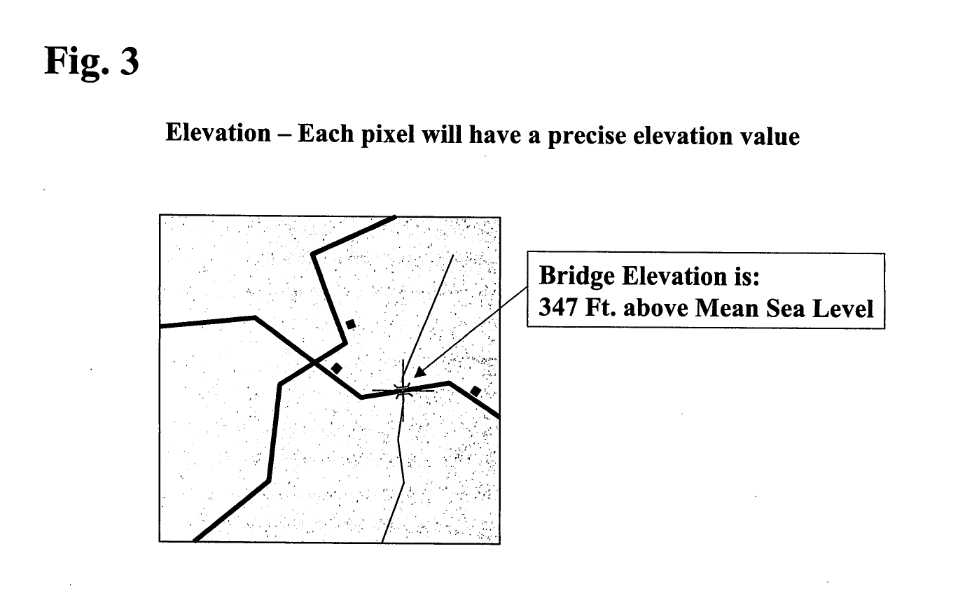

The capability to provide precise object elevation information will enhance smart weapon targeting (elevation capability shown in FIG. 3). The hypothetical target is a fairly small, re-locatable object that is intended for strike by a Precision Guided Munition from the side at a 30-degree trajectory and 5-feet off the ground. Although the X-Y axis coordinates might be precisely accurate, a 10-foot error in the Z-axis dimension will miss the target by 26-feet.

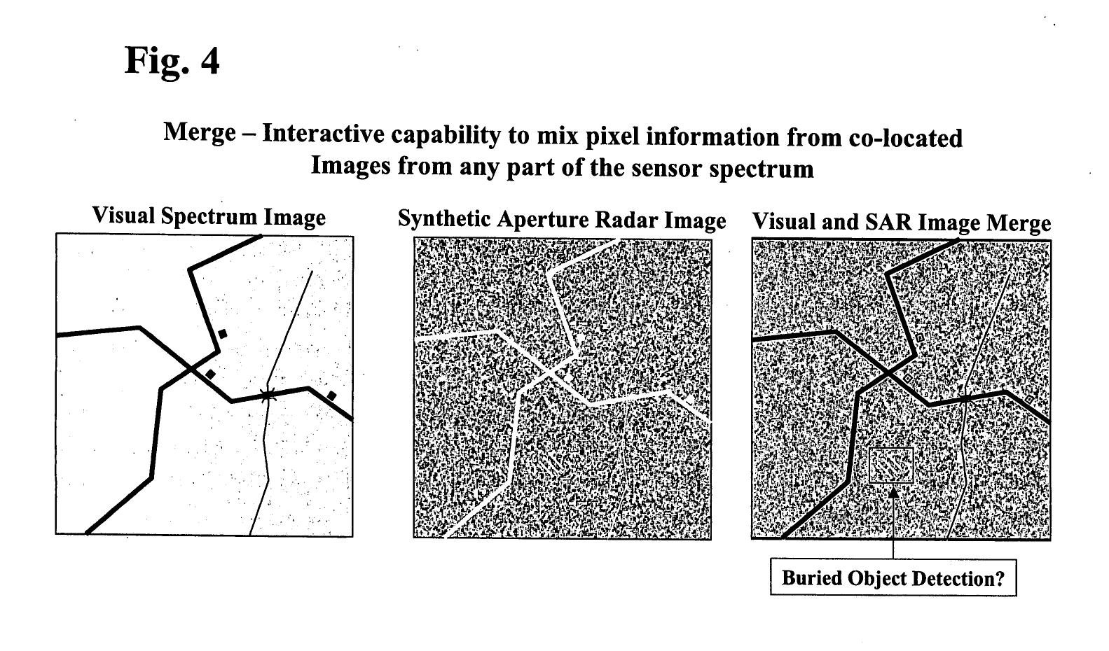

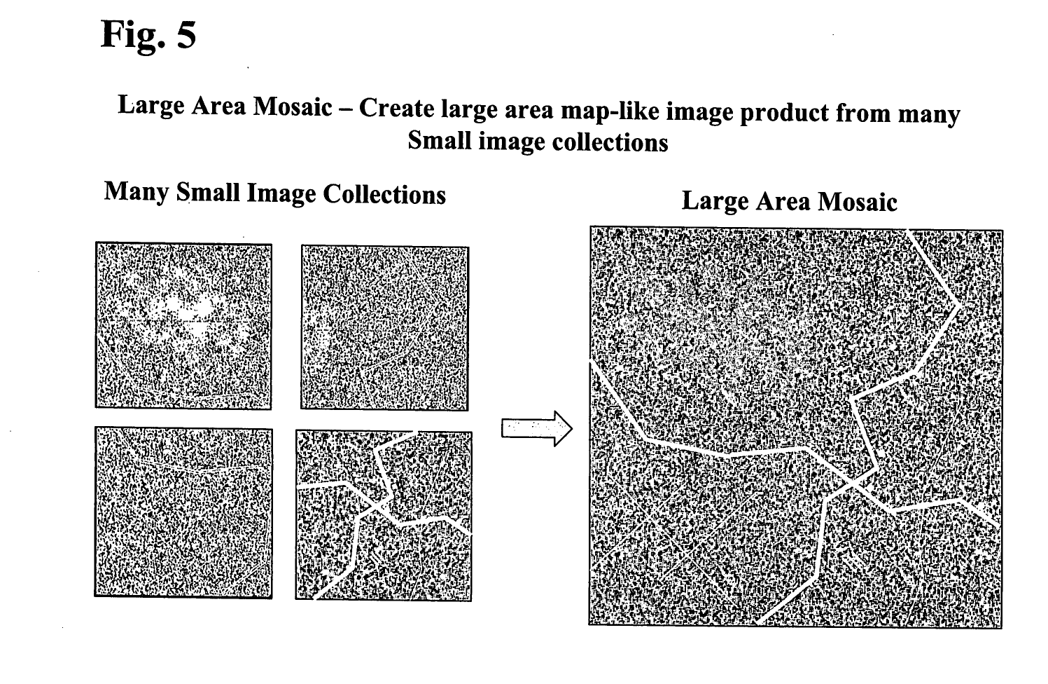

In a military operations environment, latent ISR sensor imagery is merged with other pre-existing digital map and image products (as seen in FIG. 4). The multi-spectral approach to ISR sensor imagery display may show with enhanced features, but without limitations, targets, vehicles, objects, and persons in merged or combined image form, that do not display in a single portion of the sensor spectrum. These object features will be able to be defined with all the critical elements of the Strike targeting process, to include precise geographic location, and include elevation information (as shown in FIG. 3). As seen in FIG. 5, large area mosaics will be constructed from the collection of many smaller images from any part of the sensor spectrum in order to support broad area activity analysis to include target tracking when objects of interest move outside the established norms of known locations.

The imagery analysis tool may be used to support a multi-spectral ISR collection concept of operations as described therein and may serve as a critical component of a multi-system, multi-sensor aircraft approach to the identification, analysis and destruction of target objects in near real-time. Passive electronic surveillance measures (ESM) sensors from ISR systems will detect and identify high probability threat emissions and place a proximity ellipse around their location. Imagery collection will be performed within the ESM ellipsoid in order to find precise target location information First order image sensor detection may be performed by Synthetic Aperture Radar (SAR) systems at stand-off ranges in all weather, all-light conditions. Second order image collection may be performed by electro-optic sensors. The SAR system is used for broad area search, basic target detection, and precision geolocation. Electro-optic imagery is used for high confidence target identification when collection opportunities are close to ideal. Once the imagery is collected, it will be warped, scaled and rotated (orthorectified) into the ground plane so that it reads like a map. The ground plane imagery will be geocoded so that any objects of interest can be plotted with precise geographic coordinates and elevation data in order to support effective strike targeting operations.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment contained herein.

What is claimed is:

1. A computer software system for imaging areas, the system having a set of instructions for controlling a general purpose digital computer in performing a desired function, the functions comprising:
obtaining imagery from imagery collection systems;
orthorectifying the imagery such that resultant imagery reads like a map; and
geocoding the orthorectified imagery such that all feature objects can be plotted as vector icons.

2. The system of claim 1, wherein the functions further comprising converting any input and output such that it may be interoperable within a broad user network.

3. The system of claim 1, wherein the imagery is selected from a group consisting of reconnaissance film, video tape, charts, paper graphics, maps, topographical maps, digital terrain data, radar imagery, infrared imagery, and electro-optic imagery.

4. The system of claim 1, wherein the imagery collection system can collect and store images and geospatial information.

5. An imagery analysis tool, comprising:
an imagery collector;
an orthorectifier for warping, scaling and rotating imagery collected by the imagery collector such that resultant imagery reads like a map;
a geocoder for coding the resultant imagery such that all feature objects can be plotted as vector icons.

6. The imagery analysis tool of claim 5, wherein the geocoder fixes a 3-axis coordinate for each pixel in an image scene and the geocoder can plot all feature objects as vector icons, the vector icons are transportable via low bandwidth Internal Protocol systems.

7. The system of claim 6, wherein the imagery collection system can collect and store images and geospatial information.
